(19) United States
(12) Patent Application Publication
(10) Pub. No.: US 2011/0168775 A1
(43) Pub. Date: Jul. 14, 2011

(54) AUTOMATED BEVERAGE DISPENSING SYSTEM

(76) Inventor: Jason D. Van Zetten, Oskaloosa, IA (US)

(21) Appl. No.: 12/686,724

(22) Filed: Jan. 13, 2010

(51) Int. Cl. G06F 17/00; G06F 7/08; B67D 7/84

(52) U.S. Cl. 235/381; 222/129; 235/375

(57) ABSTRACT

An automated system for dispensing of beverages to customers which allows self-dispensing of beverages while maintaining accurate accounting of purchases by a number of individual credit card holders. A self service station includes a card reader to collect payment information from a user. The station also includes an RFID tag reader to collect a distinctive code from an RFID tag on the beverage container issued to the user desiring to purchase beverages at the self service station. A processor within the station links the payment information with the particular RFID tag on the user's beverage container and records the information in a memory coupled to the processor. The processor enables a dispensing mechanism to dispense a fixed quantity of beverage into the container associated with the particular RFID tag. In another embodiment, a point of sale station may collect the payment data and link it to the RFID tag on the user's beverage container. A dispensing station equipped with an RFID tag reader collects RFID code from a container brought into proximity of the dispensing station and then interrogates the point of sale station to determine if dispensing of beverage is to be permitted.

### BACKGROUND OF THE INVENTION

Drinking establishments such as restaurant bars, entertainment venues, night clubs, taverns, and the like currently sell alcoholic beverages by taking orders from customers at the bar or via wait staff visiting tables or circulating among customers. As each order is taken, the customer is either immediately billed for the beverage purchased or is permitted to “run a tab”, that is, to continue to order beverages on an accumulating account, with each order being recorded so that later the customer can be presented with a cumulative billing. When such a drinking establishment is busy and crowded, which is a common occurrence for popular venues, the customer's ability to promptly order beverages is hampered because numbers of customers are trying to attract the attention of a limited number of bartenders or wait staff. Then, when a customer presents a credit card to make payment for his or her purchase of a beverage, further delay occurs as the wait staff person or bartender takes the credit card to a station where the card is “swiped” by a magnetic strip reader which collects data about the credit card account holder and forwards the data to a remote credit card processing entity which directs the credit purchase information to the card holder's credit card issuer who subsequently bills the card holder for his or her purchases since the last billing. When conditions are crowed in such drinking establishments, the rate at which alcoholic beverages can be sold deteriorates and the customers become impatient with delays in their purchase of beverages.

### BRIEF SUMMARY OF THE INVENTION

The present invention presents a solution to the problem of inefficient delivery of alcoholic or non-alcoholic beverages in crowded drinking establishments. The object of the invention is to provide an automated system for dispensing of beverages to customers which allows self-dispensing of beverages while maintaining accurate accounting of purchases by a number of individual credit card holders. Another object of the invention is to provide an efficient system for delivery of beverages to an array of individuals, some of whom choose to purchase a series of beverages on account, that is to run a tab, and others who choose to pay for each beverage separately.

After a bar customer has been confirmed as an eligible purchaser of alcohol, the customer is issued a glass or cup bearing a radio frequency identification (REID) tag which is adhered to the outside or bottom of the cup/glass by industrial strength glue which can withstand repeated industrial washings. The customer is permitted to carry the glass or cup to a point-of-sale device where the customer may swipe his/her credit card through a card reader and allow the point-of-sale device to read the RFID tag on the glass. The point-of-sale device links the RFID tag to the customer's credit card. Then, if the customer chooses to buy one serving of beverage at a time, the point-of-sale device will record that the possessor of the RFID tagged glass may fill it once, that is, obtain one unit of beverage, at a self-dispensing station. This information is then transmitted by the point-of-sale device, wirelessly, to the self-dispensing station. The self-dispensing station will read the RFD tag on the glass and allow a dispenser to be operated by the customer to dispense one unit of beverage. The self-dispensing station would wirelessly signal the point-of-sale device that the customer had fulfilled his/her purchase and the self-dispensing station would not operate for this customer until the point-of-sale device provides an enabling signal again showing that the customer had purchased another unit of beverage.

The point-of-sale device is signaled as to the volume (size of cup/mug/glass) which had been purchased and the self-dispensing station would then limit dispensing to the volume purchased. The point-of-sale device may also include an input device so that the customer can choose the brand of beverage desired to be dispensed.

Alternatively, the customer may “run a tab” by selecting that option at the point-of-sale device whereupon the self-dispensing station sensing the RFID tag on that customer's glass or cup would signal to the point-of-sale device that a quantity of beverage had been dispensed into the glass or cup bearing that RFID tag. Later, the point-of-sale device will report to a host computer the charges incurred and to be charged to the customer's credit card.

In another application particularly for large venues, more than one dispensing station can be provided scattered about the venue. Each dispensing station can include multiple dispensing mechanisms connected to multiple beverage supply containers. An RFID tag reader is located adjacent, and preferably in a platform on which a beverage container may be put to be filled. The RFID tag reader detects the distinct code from each RFID tag attached to a beverage container when the container is placed on the platform. Each dispensing station is coupled to a host computer which serves the group of dispensing stations. The host computer receives information about any RFID tag which has been read by the RFID tag reader and it interrogates its associated memory to determine if the RFID tag detected is linked to a credit card or other payment card. If the host computer determines that the RFID tag is linked to a payment card to which purchase of a beverage can be charged, the host computer signals the dispensing station enabling the dispensing mechanism at which the consumer's container has been placed to proceed to discharge the beverage related to that dispensing mechanism.

If the host computer does not determine that the RFID tag on the beverage container placed at the dispensing station is not linked to payment authority, then the host computer can cause an input device associated with the dispensing station to visually inform the consumer that no beverage will be dispensed until payment information has been entered. At that time the consumer may swipe his credit card through a card reader coupled to the input device, while contemporaneously the RFID tag attached to a container in the possession of the consumer can be read by another RFID tag reader near the input device. The code from the RFD tag on the consumer's container is passed to the host computer along with payment information such as credit card account information entered by the passing of the customer's credit card or other payment card through a slot on the credit card reader. The host computer receiving this information correlates the credit card data with the RFID code and then enables the dispensing station to either receive selections of the consumer's choice on the input device at the dispensing station, or else the consumer may place his or her container below the dispensing mechanism that dispenses the type or brand of beverage contained in the supply coupled to that dispensing mechanism. The RFID tag reader at the dispensing mechanism then detects the RFID code and inquires with the host computer whether beverage may be dispensed. Because the consumer has entered payment data and that data is associated with the RFID tag on the consumer's container, the host computer will enable the dispensing mechanism to deliver the beverage of the consumer's choice.

The input device may include touch screen buttons on the visual display through which the consumer may make choices of type, brand, and quantity of beverage to be purchased and charged to the consumer's payment card.

The host computer may be part of a point-of-sale station which includes a input device, display, card reader, and RFID tag detector so that a consumer who elects to enter payment data to be associated with the RFID tag on his or her beverage container can select his purchase of beverage at the input device of the point-of-sale station.

### BRIEF DESCRIPTION OF THE SEVERAL VIEWS OF THE DRAWING(S)

FIG. 1 is a schematic diagram of the components of the dispensing system invention.

FIG. 2 is a block diagram illustrating the components of the automated beverage dispensing system.

FIG. 3 is a front elevation of a serving container such as a glass, mug or cup fitted with an RFID tag according to the present invention.

FIG. 4 is a bottom plan view of an alternate serving container fitted with an RFID tag according to the present invention.

FIG. 5 is a block diagram illustrating an alternate embodiment of the invention.

FIG. 6 is a diagram of an embodiment of the system invention which includes multiple dispensing stations coupled to a host computer.

FIG. 7 is one embodiment of an input device which may be part of the system invention.

### DETAILED DESCRIPTION OF THE INVENTION

Throughout this disclosure, like items are identified by like reference numerals.

The present invention provides an automated dispensing system 2 for self dispensing of beverages by a customer of a drinking establishment.

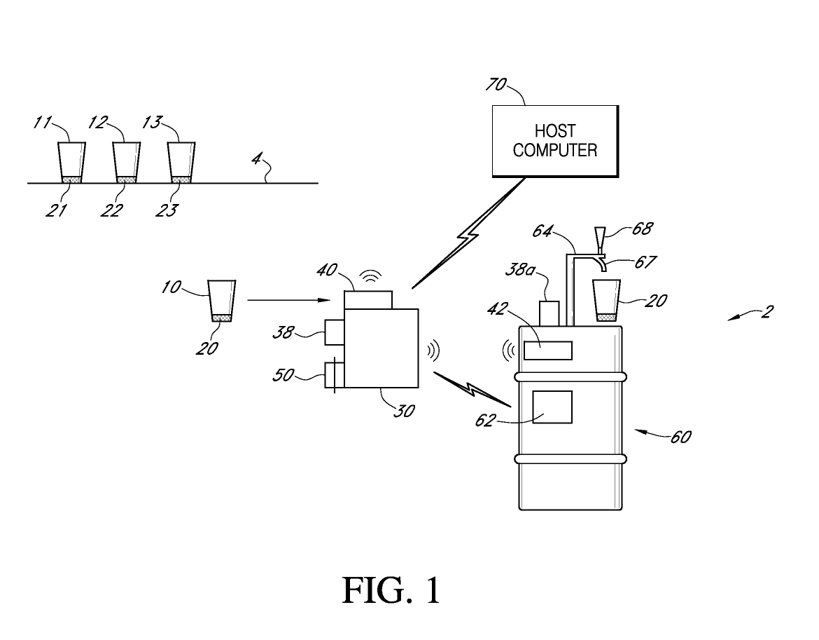

FIG. 1 illustrates the dispensing system 2 schematically. The drinking establishment provides a number of single serving beverage containers 10, 11, 12, 13 et seq. including first beverage container 10, each of which can hold a fixed volume of liquid beverage. First glass 10 is provided with a first RFID tag 20 which is readable by an RFID tag reader such as first RFID tag reader 40 which is part of point-of-sale device 30. Each other container 11, 12, 13 et seq. in the drinking establishment is provided with a different RFID tag 21, 22, 23 et seq. respectively. Container 11, 12, 13 et seq. may be stored on shelf 4 until needed for use by a customer. First beverage container 10 is distinguishable from each other beverage container 11, 12, 13 et seq. in the drinking establishment because of the distinctive identification code which is emitted by first RED tag 20 when excited by a tag reader such as first RFID tag reader 40.

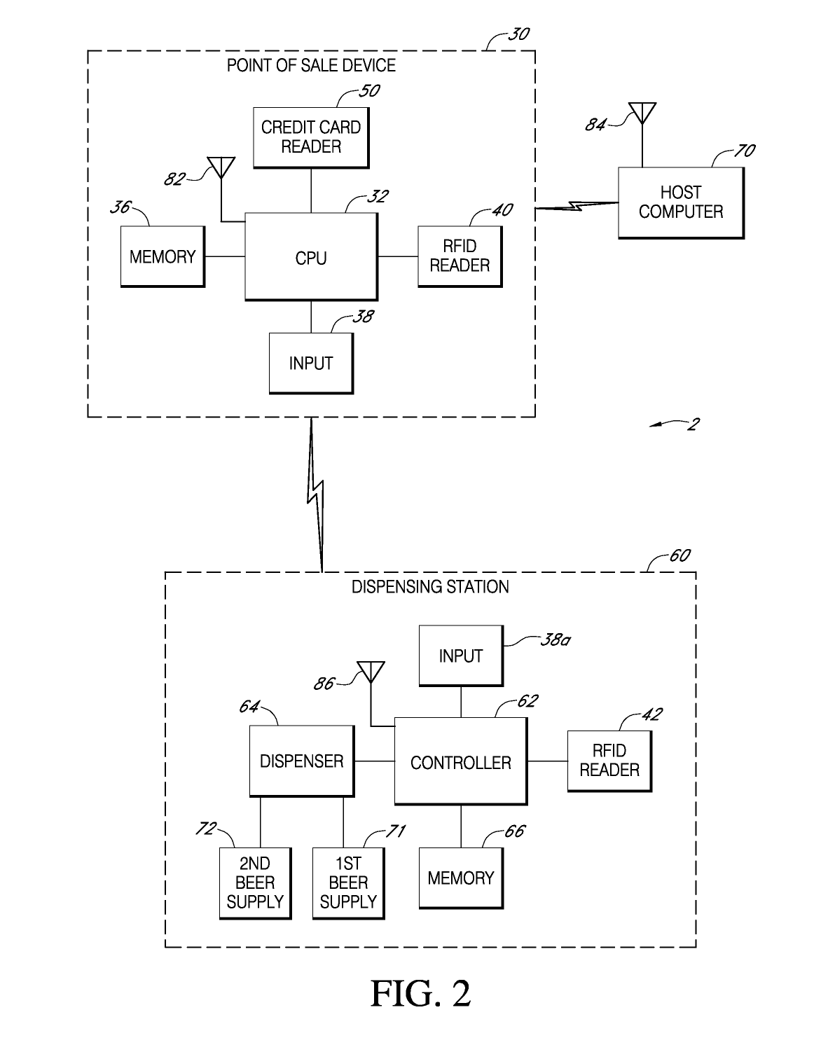

Each RFID tag 20, 21, 22, 23 et seq. affixed to a container 10, 11, 12, 13 et seq. provides an identification code when excited by an RFID tag reader 40, 42, with each RFID tag 20, et seq. emitting a distinctive code from that of every other RFID tag used at the particular drinking establishment. Each RFID tag reader 40, 42 is coupled, optionally wirelessly, to a processing unit 32 (See FIG. 2), such as a microcomputer, which receives the code of the RFID tag 20 then being detected by the RFID tag reader 40, and the processing unit 32 (See FIG. 2) interprets the code in order to provide an output signal to a host computer 70 which may be part of the point-of-sale device 30 or as illustrated in FIG. 1 may be separate from but coupled wirelessly or by cables to point-of-sale device 30.

Each RFID tag 20, 21, 22, 23 et seq. is a passive device which may be excited by radio frequency energy emitted by first tag reader 40, as the individual RFID tag 20, 21, 22, 23 et seq. comes into transmission range of the first or second tag readers 40, 42. Upon excitation by either tag reader 40, 42, with RF energy at a preselected frequency, the excited RFD tag 20, et seq. on container 10, et seq. emits or expresses a code (a series of data or a data string) particular to that individual RFID tag. Tag reader 40, 42 detects and receives the emitted code.

When first container 10 is brought near to first RFID tag reader 40 of point-of-sale device 30, the first RFID tag reader 40 excites first RFID tag 20 fixed to first container 10 which causes first RFID tag 20 to emit its distinctive identification code. The identification code of first RFID tag 20 is detected by first tag reader 40 and communicated to the processing unit 32 associated with point-of-sale device 30. The customer possessing first container 10 may present a credit card or other coded payment card used to make purchases, such as a debit card, gift card or similar substitute for currency. The credit card will have its magnetic strip or other data carrying medium read by card reader 50. Conventionally, the customer will pass the magnetic strip of the credit card through a slot in the card reader 50 which will allow card reader 50 to collect data about the customer's credit card account for billing purposes, in a process commonly referred to as “swiping” the credit card. Other card reading devices may be substituted for card reader 50 such as optical code readers, RFID tag readers, etc. provided such alternative devices can collect account information from the credit card presented by the customer. The data collected by the card reader 50 is communicated to the processing unit 32 within the point-of-sale device 30. The processing unit 32 within point-of-sale device 30 links the customer credit card data to the identification data emitted by RFID tag 20. At point-of-sale device 30, the customer selects whether he or she desires to purchase one serving or multiple servings of beverage at input device 38, the customer, having earlier presented proof to the staff of the drinking establishment at which system 2 is located, of authority to purchase alcoholic beverages, if alcoholic beverages are available at the drinking establishment and desired by the customer. The customer may select the nature, type, brand and quantity of beverage desired by operating input device 38. A display may be provided to provide visual feedback in response to commands entered at the input device 38. Having received instructions about the nature, brand, type and quantity of beverage desired to be purchased, the point-of-sale device 30 communicates the identification data from first RFID tag 20 to the dispensing station 60. A controller 62 associated with dispensing station 60 stores the RFID data identifying RFID tag 20 along with other data such as the quantity, type and brand of beverage which has been purchased at point-of-sale device 30. When the customer brings first container 10 within proximity of dispensing station 60 such that first RFD tag 20 is within range of second RFID tag reader 42 such that second RFID tag reader 42 may excite first RFID tag 20 on first glass 10, then second RFID tag reader 42 causes first RFID tag 20 to emit its distinctive identification code. The identification code of the first RFID tag 20 is detected by second tag reader 42 and is compared with data stored by controller 62 to determine if first glass 10 should be filled. Once the controller 62 determines that the bearer of first glass 10 has purchased a quantity of beverage at point-of-sale device 30, controller enables dispensing mechanism 64 to be operable to dispense a fixed quantity of beverage. The customer can then locate container 10 below spout 67 and operate lever 68 to cause the dispensing station 60 to dispense a serving of beverage into container 10. Dispensing mechanism 64 may alternatively detect presence of a container 10 below spout 67 and dispense without further activity by the customer, if the dispensing mechanism 64 is so equipped. Once the dispensing station 60 detects that the purchased quantity of beverage has been delivered by dispensing mechanism 64, controller 62 disables dispensing mechanism 64.

Dispensing station 60 may be optionally provided with an associated input device 38a which the customer may use to enter or alter his or her choice of beverage, thereby overriding selections made at first input device 38 of point-of-sale device 30 or by entering new choices. Dispensing station 60 may be further optionally provided with a second card reading mechanism (not shown) which may be used by customer to authorize payment for additional quantities of beverage without having to revisit point-of-sale device 30. The second card reading mechanism would be functionally equivalent to card reader 50 of point-of-sale device 30. That is, the second card reading mechanism associated with a dispensing station 60 could collect data such as credit card account data, debit card data, or balance remaining on a gift card, depending on what medium is used by a customer to make payment for beverages purchased.

It is to be understood that in some environments, point-of-sale device 30 and dispensing system 60 may be further equipped with currency accepting devices to accept payment for beverage orders in currency.

Controller 62 then may communicate to point-of-sale device 30 that dispensing of the purchased quantity of beverage into first glass 10 is complete. Point-of-sale device 30 may then communicate the completion of the beverage purchase transaction to a host computer 70 or it may store the data internally for later transmission to host computer 70 or to another inventory control mechanism.

Referring now to FIG. 2, further detail about the components of first embodiment of system 2 are illustrated. Point-of-sale device 30 comprises processing unit 32 to which is coupled a card reader 50, a first RFID tag reader 40, an input device 38, antenna 82 and memory 36. When a customer carrying a beverage container such as first container 10 equipped with first RFID tag 20 (FIG. 1), first RFID tag reader 40 emits a radio frequency signal which excites the first RFID tag 20 and causes it to emit an identification code which is singular to first RFID tag 20. This singular identification code of first RFID tag 20 is distinguishable from the identification code of each other RFID tag 21, 22, 23 et seq. present on the premises where system 2 is installed. The identification code of first RFID tag 20 is detected by first RFID reader 40 and it communicates the emitted code to processing unit 32. The card reader 50 coupled to processing unit 32 is used to collect data from customer's payment card, for instance a credit card or debit card or gift card, which the customer presents to provide payment for purchase of beverages. Data collected from the customer's payment card is communicated to processing unit 32 which correlates it with the data from first RFID reader 40 and stores the correlated data in memory 36. The customer may enter his/her choices at input device 38 which may be a keypad, keyboard, or other input device which allows the customer to choose whether the customer wishes to pay for only one unit of beverage or to accumulate charges for beverages during the customer's visit to the drinking establishment where system 2 is installed. For example, the customer may use input device 38 to authorize charges to his/her credit card account for one or a fixed number of servings of beverage or to authorize accumulation of charges for billing to his/her credit card. In addition, the customer may choose which of multiple brands or types of beverages the customer desires to purchase. An optional display (not shown) may be coupled to the processing unit 32 to provide visual information to the customer. The purchase data entered by the customer at the input device 38 is correlated by processing unit 32 to the payment card data and RFID tag data earlier collected, and the set of data is stored in memory 36 coupled to processing unit 32. The data may also then be communicated wirelessly or via cabling to host computer 70 or that step may be deferred and accomplished in a later batch data delivery operation. Antenna 82 coupled to processing unit 32 may be used to communicate data to antenna 84 coupled to host computer 70 and to antenna 86 of dispensing station 60.

When the customer brings first glass 10 into proximity with dispensing station 60, second RFID reader 42 emits an excitation signal receivable by first RFID tag 20 mounted to first container 10, causing first RFID tag 20 to emit its distinctive identification code which is detectable by second RFID reader 42. Second RFID reader 42 collects the identification code of the first RFID tag 20 and communicates it to controller 62 associated with dispensing station 60. Controller 62 then transmits an inquiry signal, preferably wirelessly via antenna 86, to point-of-sale device 30, indicating that an RFID tag has been detected and inquiring whether point-of-sale device 30 has stored data indicating that dispensing station 60 should be enabled to dispense a quantity of beverage. Upon receiving the inquiry from dispensing station 60, the processing unit 32 of point-of-sale device 30 determines if its associated memory 36 contains data indicating that a customer has purchased a beverage unit which has not been delivered previously. Upon determining that an undispensed quantity of beverage has been purchased by the customer associated with first glass 10 and, therefore, with first RFID tag 20, point-of-sale device 30 responds to the inquiry from dispensing station 60 by indicating that the customer associated with RFID tag 20 has paid for an undispensed quantity of beverage and that the customer is associated with first RFID tag 20. In addition, selection of brand or type of beverage data, if entered by customer at input device 38 of point of sale device 30, is communicated to controller 62 of dispensing station 60. Controller 62 communicates the received data to its memory 66 for storage. Controller 62 then signals dispensing mechansim 64 enabling dispensing mechansim 64 to dispense the quantity of beverage from the selected source between first beverage supply 71 and second beverage supply 72. The customer may then operate the dispensing mechansim 64 and self dispense the appropriate quantity of selected beverage into the first glass 10 possessed by the customer.

Once the dispensing of the beverage is complete, the dispensing station 60 communicates to point-of-sale device 30, wirelessly via antennae 82, 86 or otherwise, that the purchased quantity of beverage has been dispensed and processing unit 32 records this information in its associated memory 36.

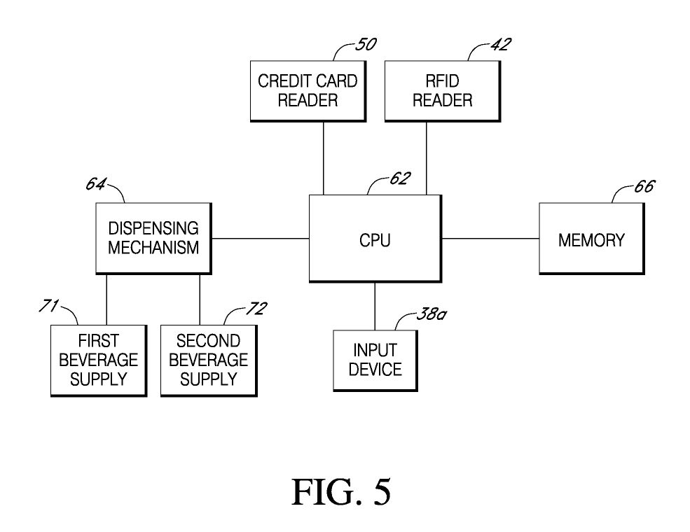

It is to be understood that point-of-sale device 30 and dispensing station 60 may alternatively be combined into a single station, thereby eliminating duplication of card readers, RFID tag readers and input devices. Specifically, as shown in FIG. 5, in an alternative embodiment of invention 2, the dispensing station 60 may be the sole station used in the beverage dispensing system 2, with dispensing station 60 including a card reader such as first card reader 50 coupled to a controller 62 coupled to a memory 66. The second RFID tag reader 42 will excite any RFID tag 20 et. seq. brought into proximity with second RFID tag reader 42 and will detect the code emitted by the particular RFID tag 20 et. seq. on a particular container 10 et seq. The emitted code of the particular RFID tag may then be stored in the memory 66 and linked to the payment data from whatever credit card, debit card or gift card that a customer has presented for payment data collection by the card reader 50. The controller 62 (e.g. a microcomputer) links the RFID code from the particular RFID tag 20 et. seq. detected by the second RFID tag reader 42 to the payment data collected by the card reader 50. The controller 62 may also link selection data entered by the customer at an input device 38a associated with dispensing station 60. All purchase authorization data collected by the card reader 50 which is correlated with the RFID code from the RFID tag, say RFID tag 20, and which is further correlated with selection data entered at input device 38a, may be stored in memory 66. Once the data is stored in memory 66, the controller 62 will enable dispensing mechanism 64 to be operated to dispense the particular beverage purchased. Data stored within memory 66 optionally may be transmitted to a host computer 70 or to other inventory control and accounting system components or the data may be directly transmitted to a payment card processing system (not illustrated) for purposes of collection of funds from the issuer of the credit card, debit card, gift card or other currency substitute used by customer of the establishment to purchase beverages.

If the customer so desires, the customer may enter commands at the input device 38a to authorize multiple purchases to be charged against a given credit card or debit card account. The controller 62 would then interrogate memory 42 to determine if dispensing of additional beverage quantities should be made when second RFID tag reader 42 detects a particular RFD tag 20 which has been correlated with purchase data such as a credit card account to be charged with a series of purchases.

Likewise, a customer may enter data at the input device 38a to link the customer's credit card or other payment means with more than a single RFID tag (for example RFID tags 21, 22 et seq associated with beverage containers 11, 12) so that the customer could arrange to pay for beverages of the customer's friends who possess beverage containers bearing RFID tags which have been associated with the customer's payment card information. In particular, the customer could swipe his credit card through the card reader 50 and make selections at the input device 38a to indicate that a fixed number of RFID tags are desired to be linked to the payment card data from the customer's credit card. The customer would then bring each beverage container which the customer wished to link to his/her credit card into proximity with the RFID reader 42 and allow the RFID reader 42 to excite the RFID tags on the selected beverage containers 10 et seq. and make selections at the input device 38a authorizing charging of purchases associated with the beverage containers 10 et seq. to the customer's payment card data, with the customer later interrogating the input device 38 to cause the controller 62 to report a list of charges made to the customer's payment card.

If the drinking establishment supplies only beverages which are non-alcoholic, no age eligibility evaluation would be necessary while the beverage dispensing system 2 could be operable to dispense only beverages appropriate for all consumers. If the establishment is licensed to serve both alcoholic and non-alcoholic beverages, the staff of the establishment will control which containers 10, 11, 12 et. seq. would be provided to eligible alcohol consumers and the controller 62 could be preprogrammed with a list of RFID codes associated with RFID tags on containers into which alcoholic beverages may not be dispensed.

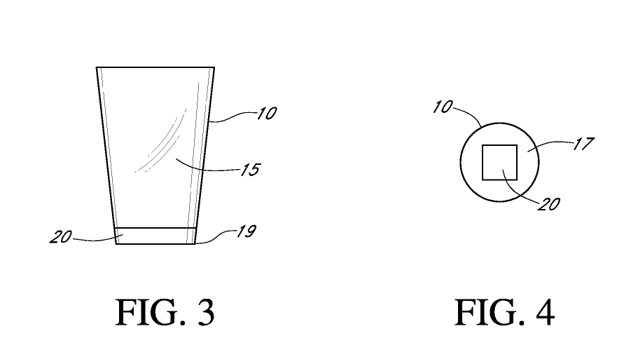

Referring now to FIGS. 3 and 4, alternate methods of affixation of first RFID tag 20 to first beverage container 10 may be observed. In FIG. 3, the first RFID tag 20 is adhered to sidewall 15 of first beverage container 10, preferably near lower end 19 thereof. Preferably first RFID tag 20 is adhered to first beverage container 10 by an adhesive which can withstand repeated washings and application of industrial strength detergents. However, alternatively, first RFID tag 20 may be embedded in the sidewall 15 or bottom 17 of the container 10 during its manufacture.

In FIG. 4, an alternate location for first RFID tag 20 is the bottom 17 of first beverage container 10 where the RFID tag 20 may be adhesively fixed or in which it may be encapsulated or embedded.

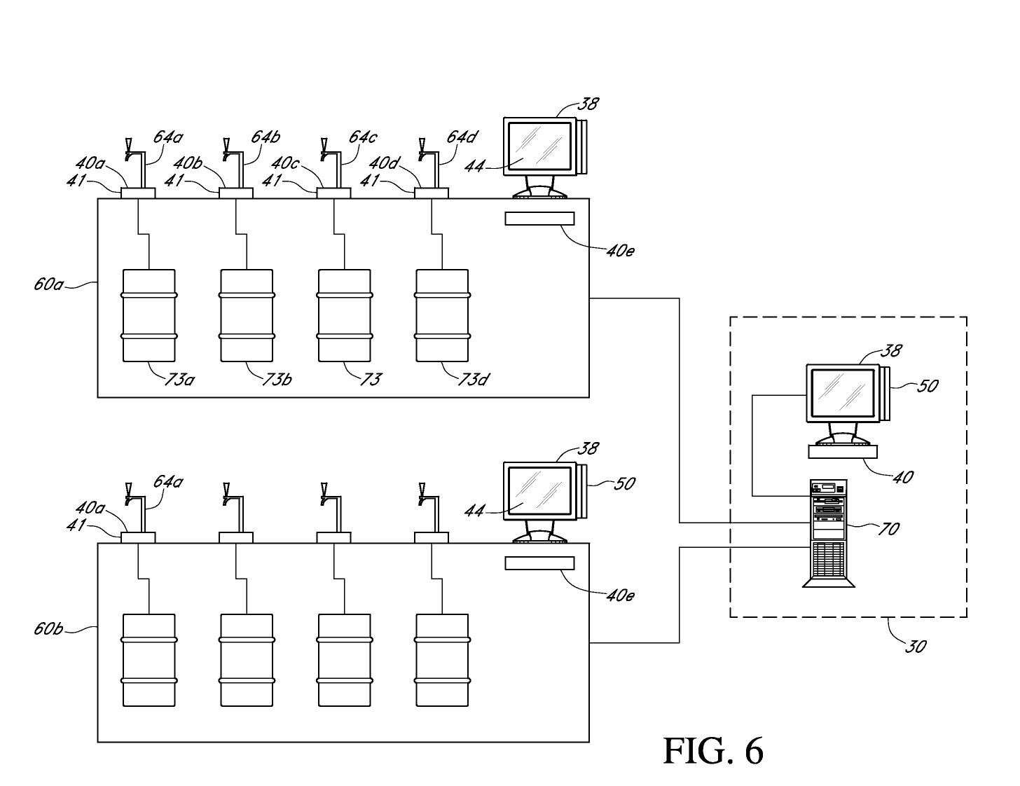

FIG. 6 discloses an alternative embodiment of the dispensing system 2 wherein multiple dispensing stations, 60a, 60b, may be distributed about the premises of a large venue where beverages are available for purchase by consumers. It is to be understood that though only two dispensing stations 60a, 60b are shown, many more dispensing stations could be used in a large venue.

Each of dispensing stations 60a, 60b, is coupled to a host computer 70 which may be part of a point-of-sale device 30. Dispensing stations 60a, 60b are each provided with multiple dispensing mechanisms 64a, 64b, 64c, 64d, each of which is connected to a beverage supply 73a, 73b, 73c, 73d. Each beverage supply 73a, 73b, 73c, 73d may contain a different beverage. For example, beverage supplies 73a and 73b may contain different brands of beer, while beverage supplies 73c and 73d may contain nonalcoholic beverages. Associated with each dispensing mechanism 64a, 64b, 64c, 64d is an RFID tag reader 40a, 40b, 40c, 40d.

When customer places a beverage container on a platform 41 housing, RFID tag reader 40a, the RFID tag attached to the beverage container is excited and emits its distinctive code which is collected by the RFID tag reader 40a. This code is transmitted to host computer 70 where it is compared with data in memory which may indicate that that particular RFID tag is linked to payment card data previously collected and if so, the host computer 70 transmits a signal to dispensing mechanism 60a to dispense a fixed quantity of beverage from beverage supply 73a dispensing machine 64a at which the customer has placed a beverage container. If host computer 70 does not detect payment card data linked to the RFID tag 20 detected by RFID tag reader 40a, the host computer 70 transmits a signal to the display 44 of input device 38 causing it to display instructions to the customer to provide payment arrangements by passing the customer's payment card through card reader 50. The customer is also instructed to place his/her beverage container in proximity to RFID tag reader 40a which is located near input device 38a. The data collected by card reader 50 is transmitted to host computer 70 which links the payment data with the RFID code of the RFID tag read by RFID tag reader 40a. Host computer 70 then signals dispensing station 60a to dispense beverages from whichever of dispensing mechanism 64a, 64b, 64c or 64d at which the customer has located his/her beverage container.

If a customer places a beverage container 10 on the platform housing RFID tag reader 40b and the customer has already provided payment card data to host computer 70 by use of card reader 50, then detection of a given RFID tag that is linked to payment data results in the host computer 70 enabling dispensing mechanism 64b to dispense beverage from beverage supply 73b. If the customer who has previously supplied payment data to host computer 70 places his or her beverage container at RFID tag reader 40d, then host computer 70 will enable dispensing mechanism 64d to dispense a fixed volume of the beverage from beverage supply 73d and the customer's payment card account will be charged accordingly.

It is to be understood that dispensing mechanisms 64 et seq may be ganged into groupings but in general, each dispensing mechanism 64 is supplied by one particular beverage supply 73. Hence it is to be understood that a multiplicity of dispensing stations 60 may be dispersed throughout a venue such that customers who desire to purchase beverages without intervention of a bartender or serving staff may approach any of dispensing station 60 and purchase a desired beverage using a payment card and self-service operation, provided of course, that they possess a beverage container to which an RFID tag is attached and provided further that any applicable age qualification to purchase the desired beverage has been met and associated with the RFID tag affixed to the particular customer's beverage container. As a result of implementation of this system, long lines at beverage supply counters are alleviated and the venue proprietor may be able to staff its venue with fewer wait staff and bartenders.

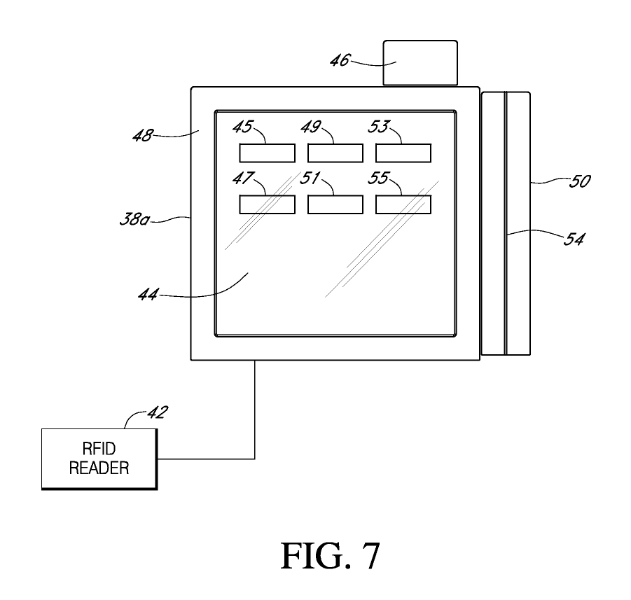

FIG. 7 discloses an embodiment of input devices 38, 38a which may be employed in the beverage dispensing system 2.

Input device 38a may also include a display 44 and touchscreen buttons 45, 47, 49, 51, 53, 55 defined by a graphic user interface driving the display 44. Touchscreen buttons 45, 47, 49, 51, 53, 55 may be selectively employed by a customer to enter the customer's selections of beverage where each touchscreen button 45, 47, 49, 51, 53, 55 represents a different type, quantity, or brand of beverage. A printer 46 may be associated with input device 38a to print a receipt for the use of the customer using the input device 38a. In FIG. 7 printer 46 is mounted to the housing 48. However, printer 46 may stand alone but be electrically coupled to a microcomputer such as controller 62 illustrated in FIG. 5, the microcomputer preferably being housed within housing 48 of input device 38a.

A card reader 50 which is equipped with a slot 54 may be mounted to the housing 48 of display 44. Card reader 50 is electrically coupled to the microcomputer within input device 38.

An RFID reader 42 is also coupled to input device 38. At input device 38 a customer may hold one of beverage containers 10 et seq sufficiently close to RFID reader 42 such that an RFID tag on the container is excited by RFID reader 42 and emits its distinctive code which is detected by RFID reader 42 and provided to a controller such as processing unit 32 illustrated in FIG. 2. The customer may pass his payment card such as a credit card through slot 54 of card reader 50 so that account data stored on the payment card is collected by the card reader and then transmitted to the processing unit 32. The customer may receive visual feedback on display 44 indicating that his payment card data has been collected and that the RFID tag 20 et seq on the beverage container 10 et seq in his possession has been read and the code of the RFID tag collected and transmitted to processing unit 32. The customer may then enter a selection of desired beverage by touching one of touchscreen buttons 45, 47, 49, 51, 53, 55. Having then completed purchase of the beverage of choice, the printer 46 may be driven by processing unit 32 to print a receipt of the transaction which customer may retain.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

Having described the invention, I claim:

1. A beverage dispensing system for a retail drinking establishment comprising
a plurality of individual beverage containers suitable for containing a fixed volume of a beverage,
each of the plurality of individual beverage containers provided with an RFID tag,
each RFID tag on each of the plurality of individual beverage containers emitting a distinctive code when excited by an external radio frequency emitter,
the distinctive code of a first of the RFID tags different from the distinctive code emittable by each other RFID tag,
a point of sale device comprising a first detector operative to selectively excite the RFID tag on each of the plurality of individual beverage containers,
the first detector collecting a code of each RFID tag detected,
the point of sale device further comprising a payment card data collecting element,
the payment card data collecting element operative to collect data from a payment card operatively coupled to the payment card data collecting element,
the point of sale device further comprising a processing unit operative to correlate the payment card data of a first payment card provided to the payment card data collecting element with a distinctive code of a one of the RFID tags associated with a one of the beverage containers, the one of the RFID tags then being excited by the first detector,
a dispensing device selectively operative to dispense a beverage into each of the plurality of individual beverage containers,
the dispensing device including a second detector,
the second detector operative to excite any RFID tag brought into detection range of the second RFID detector,
the dispensing device coupled to the point-of-sale device,
the dispensing device operative to interrogate the point of sale device regarding the RFID code emitted by a one of the RFIG tags which is then being detected by the second detector,
the point of sale device operative to respond to an inquiry by the dispensing device,
the point of sale device responding to the dispensing device with instruction to dispense a volume of beverage when the point of sale device determines that the one of the plurality of RFID tags is correlated with the first payment card from which the point of sale device collected data,
the dispensing device responding to the point of sale device when a fixed volume of beverage has been dispensed to a customer carrying the beverage container equipped with the first of the RFID tags.

2. The beverage dispensing system of claim 1 wherein
each RFID tag is adhered to or embedded in the beverage container.

3. The beverage dispensing system of claim 1 wherein
each payment card data collecting element is a credit card reader,
each credit card reader obtains credit card data by sensing data on a magnetic strip of a credit card.

4. The beverage dispensing system of claim 1 wherein
the dispensing station is wirelessly coupled to the point of sale device.

5. The beverage dispensing system of claim 1 wherein
the point of sale device further comprises an input device operable by a user to make selections concerning beverages to be purchased.

6. The beverage dispensing system of claim 1 wherein
the dispensing station further comprises an input device operable by a user to make selections concerning beverages to be purchased.

7. The beverage dispensing system of claim 1 wherein
the point of sale device includes a processor and a memory coupled to the processor.

8. The beverage dispensing system of claim 1 wherein
the dispensing station dispenses from at least two sources of beverage.

9. The beverage dispensing system of claim 1 wherein
the dispensing station further comprises a manually operable dispensing mechanism operable by a user.

10. The beverage dispensing system of claim 1 wherein
at least one of the point of sale device and the dispensing station includes a memory unit,
the memory unit storing data including RFID codes detected and payment card data collected.

11. The beverage dispensing system of claim 1 wherein
a host computer is coupled to the point-of-sale device,
the point-of-sale device transmits payment card and RFID data to the host computer.

12. The beverage dispensing system of claim 11 wherein
the dispensing station is coupled to the host computer,
the dispensing station transmits data regarding dispensed beverages to the host computer.

13. A beverage dispensing system comprising
a plurality of individual beverage containers suitable for containing a fixed volume of beverage,
each of the plurality of individual beverage containers associated with an RFID tag,
each RFID tag emitting a distinctive code when excited by a detector,
the distinctive code of a first of the RFID tags different from the distinctive code emittable by each other RFID tag,
the detector collecting the distinctive code of each RFID tag detected,
a payment data collecting element operative to collect payment data from a payment card operatively coupled to the payment data collecting element.
a processing unit operative to correlate payment data of a first payment card coupled to the payment data collecting element with a distinctive code emitted by a one of the RFID tags, the one of the RFID tags then being excited by the detector.
a dispensing device selectively operative to dispense a beverage into any one of the plurality of individual beverage containers,
the processing unit operatively coupled to the dispensing device to selectively enable dispensing of beverages from the dispensing device.

14. The beverage dispensing system of claim 13 wherein
an input device is operatively coupled to the processing device,
the input device operable by a customer to make at least one selection regarding the beverage to be dispensed.

15. The beverage dispensing system of claim 14 wherein
the processing device is coupled to a printer,
the printer selectively operable to print a record of a transaction at the beverage dispensing station.

16. The beverage dispensing system of claim 14 wherein
the input device operable by a customer to instruct the processing device to correlate a payment card of the customer with the distinctive code of more than one RFID tag.

17. The beverage dispensing system of claim 13 wherein
the dispensing device is coupled to a first beverage supply,
at least a second beverage dispensing device selectively operative to dispense beverage from at least a second beverage supply coupled thereto,
each dispensing device having a detector associated therewith,
each detector operable to excite an RFID tag in proximity thereto,
the processing unit operative to determine which one of the detectors has detected a code of an RFID tag proximate thereto,
the processing unit operative to control dispensing of a beverage from the one dispensing device associated with the one detector.

18. The beverage dispensing system of claim 13 wherein
an input device is operatively coupled to the processing device,
the input device operable by a customer to authorize a series of purchases, each purchase of the series of purchases associated with payment data from the payment card operatively coupled to the payment data collecting element,
each purchase of the series of purchases associated with the one of the RFID tags then being excited by the detector.

19. The beverage dispensing system of claim 13 wherein
an input device is operatively coupled to the processing device,
the input device operable by a customer to authorize a plurality of purchases, each purchase of the plurality of purchases associated with payment data from the payment card operatively coupled to the payment data collecting element,
each purchase of the plurality of purchases associated with at least two RFID tags on at least two beverage containers,
each of the at least two RFID tags being excited by the detector,
the processing unit operative to correlate payment data of the payment card with each of the at least two RFD tags.

20. A beverage dispensing system comprising
a plurality of individual beverage containers suitable for containing a fixed volume of beverage,
each of the plurality of individual beverage containers associated with an RFID tag,
each RFID tag emitting a distinctive code when excited by RF energy,
the distinctive code of a first of the RFID tags different from the distinctive code emittable by each other RFID tag,
a multiplicity of beverage dispensing stations,
each beverage dispensing station coupled to a computer,
each beverage dispensing station comprising
a detector exciting each RFID tag detected,
the detector collecting the distinctive code of each RFID tag detected,
a payment data collecting element operative to collect payment data from a payment card operatively coupled to the payment data collecting element.
a dispensing device selectively operative to dispense a beverage into any one of the plurality of individual beverage containers,
the computer operative to correlate the payment data of a first payment card coupled to the payment data collecting element a one of the beverage dispensing stations with a distinctive code emitted by a one of the RFID tags then being excited by the detector of the one of the beverage dispensing stations,
the computer operatively coupled to the dispensing device of the one of the dispensing stations to selectively enable dispensing of beverages from the dispensing device of the one of the dispensing stations.

21. A method for dispensing beverages and collecting payment therefor comprising the steps of:
providing a plurality of individual beverage containers, each individual beverage container suitable for containing a fixed volume of a beverage,
affixing a distinctive RFID tag to each individual beverage container of the plurality of beverage containers,
each RFD tag emitting a distinctive code when excited by a first detector,
the distinctive code of a first of the RFID tags different from the distinctive code emittable by each other RFID tag,
issuing a first beverage container containing a first RFID tag to a first consumer,
collecting the distinctive code from the first RFID when the first RFID tag is excited by the detector,
collecting payment data from a payment card presented by the first consumer,
correlating payment data collected from the payment card presented by the first consumer with the distinctive code emitted by the first RFID tag affixed to the first container,
selectively enabling a dispensing device to dispense a beverage into the first container.
